(19) United States
(12) Patent Application Publication
(10) Pub. No.: US 2014/0366092 A1
(43) Pub. Date: Dec. 11, 2014

(54) DATA TRANSMISSION METHOD AND MOBILE STORAGE DEVICE USING THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 14/299,135

(22) Filed: Jun. 9, 2014

(30) Foreign Application Priority Data
Jun. 10, 2013 (TW) 102120491

(51) Int. Cl. H04L 29/06; H04L 29/08

(52) U.S. Cl. CPC H04L 63/08; H04L 67/1095
USPC 726/3; 707/610

(57) ABSTRACT

A mobile storage device is disclosed. The mobile storage device includes a wireless communication unit configured to allow the mobile storage device to be coupled to a cloud server via a network; a synchronizing unit configured to transmit data between the mobile storage device and the cloud server; and a storage unit configured to store data.

### FIELD

Embodiments of the present disclosure generally relates to apparatus and method for data synchronization, and particularly to data synchronization method for a mobile electronic device and a mobile electronic device using the same.

### BACKGROUND

Mobile storage devices, for example flash memory, flash disks, mobile hard disk drives, or portable digital audio and/or video players are popular due to their portability. In general, a mobile storage device can be coupled to an electronic device via an external device interface for data transmission. The external device interface can be an external universal serial bus (USB) interface. The electronic device can be a computer. If a client device, for example, a mobile phone wants to obtain data from the mobile storage device, data of the mobile storage device should be transmitted to a computer and then transmitted from the computer to the client device. Moreover, once the external device interface of a mobile storage device is damaged, the mobile storage device cannot be coupled to the electronic device for data transmission.

### BRIEF DESCRIPTION OF THE DRAWINGS

Implementations of the present technology will now be described, by way of example only, with reference to the attached figures, wherein:

FIG. 1 is a block diagram of an example embodiment of a mobile storage device in a possible use environment.

FIG. 2 is a diagram of an example embodiment of a mobile storage device.

FIG. 3 is a flowchart of an example embodiment of a data transmission method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

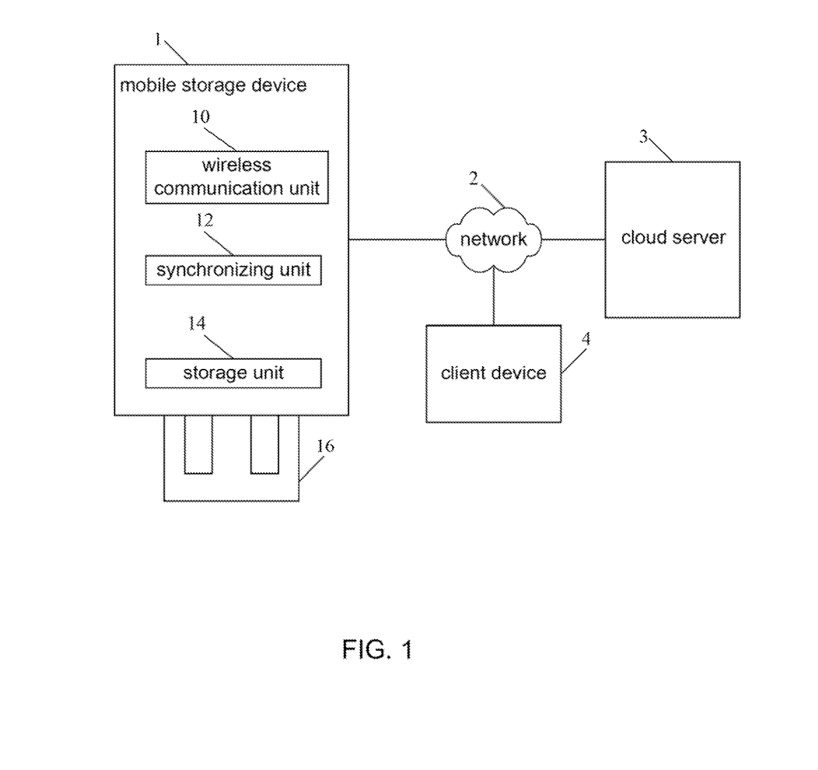

FIG. 1 is a block diagram of one embodiment of a mobile storage device 1. The mobile storage device 1 can be coupled to the cloud server 3 via the network 2. A Client device 4 can be connected to the cloud server 3 via the network 2 for accessing data stored in the cloud server 3. The mobile storage device 1 can be flash memory, a flash disk, a mobile hard disk drive, or a portable digital audio and/or video player. The network 2 can be the Internet, a wireless mobile communication network or any other public accessible networks. The client device 4 can be a mobile phone, an electronic book, or other consumer electronic device having a storage unit.

The mobile storage device 1 can include a wireless communication unit 10, a synchronizing unit 12, and a storage unit 14. The wireless communication unit 10 can be configured to allow the mobile storage device to be coupled to the network 2. The synchronizing unit 12 can be configured to transmit data to the cloud server 3 and downloading data from the cloud server 3. The storage unit 14 can be configured to store data.

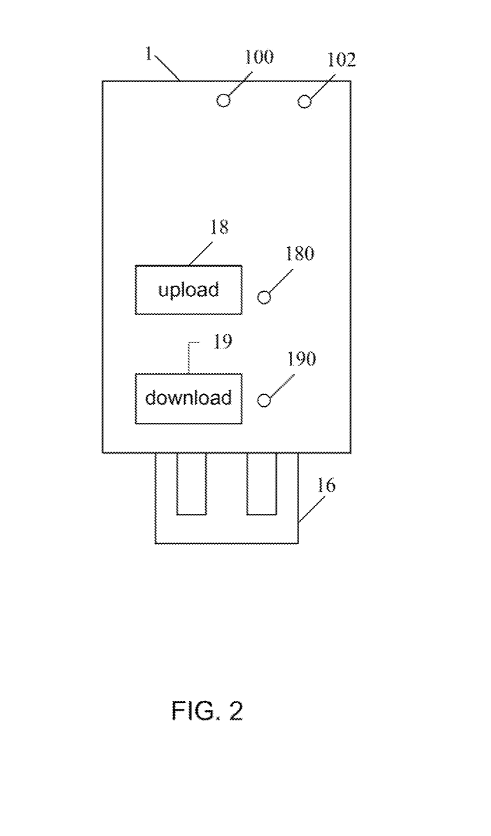

FIG. 2 is an exemplary diagram of one embodiment of a mobile storage device. The mobile storage device 1 can include a “upload” button 18 and a “download” button 19 on a surface thereof. When the “upload” button 18 is pressed, data of the mobile storage device 1 is transmitted to the cloud server 3. When the “download” button 19 is pressed, data is transmitted from the cloud server 3 to the mobile storage device 1. In another embodiment, the mobile storage device 1 can have no “download” button thereon, and only “upload” button 18 is configured on the surface of the mobile device. In other embodiments, the mobile storage device 1 has no “upload” button thereon, and only “download” button 18 is configured on the surface of the mobile device.

In at least one embodiment, the mobile storage device 1 can have some indication lamp configured on a surface of the mobile device. For example, a first indication lamp 100 can be configured to indicate whether a connection between the mobile storage device and the network is set up. A second indication lamp 102 can be configured to indicate whether a connection between the mobile storage device and the cloud server is set up. A third indication lamp 180 and a fourth indication lamp 190 can be configured to indicate a state of data transmission between the mobile storage device 1 and the cloud server 3. Referring to FIG. 2 again, the third indication lamp 180 can be configured adjacent to the “upload” button 18 and the fourth indication lamp 190 can be configured adjacent to the “download” button 19. When data transmission from the mobile storage device to the cloud server begins, the third indication lamp 180 is lighted. Once the data transmission from the mobile device 1 to the cloud server 3 is finished, the third indication lamp 180 is off. Similarly, when data transmission from the cloud server to the mobile storage device begins, the fourth indication lamp 190 is lighted. Once the data transmission from the cloud server 3 to the mobile device 1 is finished, the fourth indication lamp 190 is off. In another embodiment, the third indication lamp 180 and the fourth indication lamp 190 can be combined to one indication lamp.

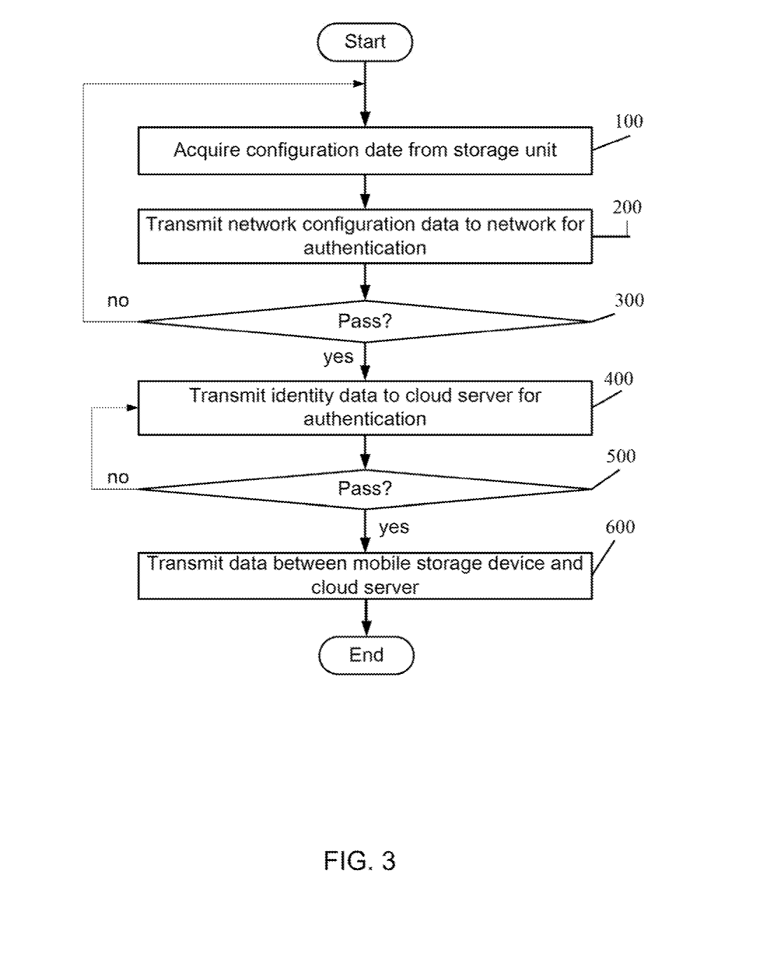

FIG. 3 is a flowchart of one embodiment of a data transmission method for a mobile storage device. Depending on the embodiment, additional steps may be added, others removed, and the ordering of the steps may be changed.

At block 100, a wireless communication unit acquires configuration data of the mobile storage device when a user wants to perform data transmission between the mobile storage device and a cloud server. In at least one embodiment, a “upload” button or a “download” button can be pressed to activate the procedure. The configuration data can include network configuration data, and identity data of the mobile storage device. The network configuration can be transmitted to the network for authentication. Once the authentication is passed, the mobile storage device can be connected to the network successfully. The identification data of the mobile storage device can be transmitted to the cloud server for authentication. The data transmission between the mobile storage device and the cloud server can be done only if the authentication is passed by the cloud server.

At block 200 and block 300, the network configuration is transmitted to a network for authentication. If the authentication is passed, a connection between the mobile storage device and the network is set up and a first indication lamp is lighted to indicate that the connection is set up successfully. Otherwise, if the authentication is not passed, the first indication lamp is not lighted and the procedure goes back to block 100.

At block 400 and block 500, the identity data of the mobile storage device is transmitted to a cloud server for authentication. If the authentication is passed, a connection between the mobile storage device and the cloud server is set up. A second indication lamp configured on a surface of the mobile storage device is lighted to indicate the connection is set up successfully. Otherwise, if the authentication is not passed, the second indication lamp is not lighted and the procedure goes back to block 400.

At block 600, data transmission between the mobile storage device and the cloud server begins and a third indication lamp is lighted. When the data transmission between the mobile storage device and the cloud server is finished, the third indication lamp is turned off. The data stored in the cloud server can be protected based on identity data of client devices. A client device can only access data related to its identity data. For example, if a “download” button of a mobile storage device is pressed to activate downloading data from the cloud server to the mobile storage device, only data related to identity data of the mobile storage device can be transmitted from the cloud server to the mobile storage device.

In other embodiments, other type indicators can be used instead of above mentioned indication lamps, for example, sound or vibration.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein to fall within the scope of this disclosure and the following claims.

What is claimed is:

1. A mobile storage device, comprising:
a wireless communication unit configured to allow the mobile storage device to be coupled to a cloud server via a network;
a synchronizing unit configured to transmit data between the mobile storage device and the cloud server; and
a storage unit configured to store data.

2. The mobile storage device according to claim 1, wherein the data stored in the storage unit includes configuration data of the mobile storage device, and the configuration data includes network configuration data and identity data of the mobile storage device, wherein the network configuration data can be transmitted to the network for authentication, and the identity data of the mobile storage device can be transmitted to the cloud server for authentication if the authentication is passed by the network.

3. The mobile storage device according to claim 2, wherein the data transmission can be performed only when the authentication is passed by the cloud server.

4. The mobile storage device according to claim 1, wherein the data transmission between the mobile storage device and the cloud server includes data transmission from the mobile storage device to the cloud server.

5. The mobile storage device according to claim 1, wherein the data transmission between the mobile storage device and the cloud server includes data transmission from the cloud server to the mobile storage device.

6. The mobile storage device according to claim 1, further including a “upload” button which can be pressed to activate the data transmission from the mobile storage device to the cloud server.

7. The mobile storage device according to claim 1, further including a “download” button which can be pressed to activate the data transmission from the cloud server to the mobile storage device.

8. The mobile storage device according to claim 1, further including an indicator for indicating a state of the data transmission.

9. The mobile storage device according to claim 1, further including an indicator for indicating whether the authentication is passed by the network.

10. The mobile storage device according to claim 1, further including an indicator for indicating whether the authentication is passed by the cloud server.

11. A data transmission method, comprising:
transmitting, at a mobile storage device, network configuration data to a network for authentication;
transmitting, at the mobile storage device, identity data of the mobile storage device to a cloud server if the authentication is passed by the network;
transmitting, at the mobile storage device, data from the mobile storage device to the cloud server if the authentication is passed by the cloud server.

12. The data transmission method according to claim 11, further comprising giving an indication when the data transmission begins.

13. The data transmission method according to claim 11, further comprising giving an indication when the data transmission is finished.

14. The data transmission method according to claim 11, further comprising giving an indication when the authentication is passed by the network.

15. The data transmission method according to claim 11, further comprising giving an indication when the authentication is passed by the cloud server.
